(19) United States
(12) Patent Application Publication
(10) Pub. No.: US 2008/0186280 A1
(43) Pub. Date: Aug. 7, 2008

(54) MOUSE APPARATUS AND COMPUTER SYSTEM HAVING SAME

(75) Inventor: JEN-TSORNG CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/848,191

(22) Filed: Aug. 30, 2007

(30) Foreign Application Priority Data
Feb. 2, 2007 (CN) 200710200149.4

(51) Int. Cl. G06F 3/033

(52) U.S. Cl. 345/166

(57) ABSTRACT

A mouse apparatus configured for concurrently controlling a cursor displayed on a display screen connected to a host unit of an information technology system includes: a light pointer emitting invisible light in a predetermined wavelength range toward the display screen and forming an invisible light spot thereon, a selectively reflective layer disposed over the display screen and configured for reflecting the light spot, a number of light sources sparsely fixedly disposed near edges of the display screen, an image sensing module for capturing images of the light sources and the reflected light spot, and a processor for processing images sensed by the image sensing module and outputting a control signal to the host unit to position the cursor on the display screen. A method for concurrent cursor control is also provided.

### BACKGROUND

1. Field of the Invention

The present invention relates to input devices for information technology systems for remotely controlling information technology systems, and more particularly to a mouse apparatus for concurrent cursor control.

2. Description of Related Art

A mouse is a popular input and control device for information technology systems such as computers, gaming machines etc. To operate a mouse connected to an information technology system, a user typically moves a mouse along a surface. The mouse senses such movement by mechanical or optical means, and sends a corresponding control signal to the information technology system to concurrently control a cursor displayed by the information technology system. The mouse communicates with the information technology system by a wire or a wireless means.

With a conventional mouse, a movement for controlling an information technology system imparted by a user is typically confined to a two dimensional plane. However, in situations such as three-dimensional gaming, it is often desirable for the user to be able to concurrently control the cursor by moving the mouse in a three-dimensional manner.

### SUMMARY

A mouse apparatus, in accordance with a preferred embodiment, is provided. The mouse apparatus is configured (i.e., structured and arranged) for concurrently controlling a cursor displayed on a display screen of a display unit. The display unit is connected to a host unit of an information technology system. The mouse apparatus includes a light pointer, a selectively reflective layer, multiple light sources, an image sensing module and a processor. The light pointer is configured for emitting invisible light in a predetermined wavelength range toward the display screen and forming an invisible light spot thereon. The selectively reflective layer is disposed over the display screen and configured for reflecting light in the predetermined wavelength range. The multiple light sources are sparsely disposed near edges of the display screen. The image sensing module is configured for capturing images of light emitted from the light sources and the light spot reflected from the selectively reflective layer. The processor is configured for receiving images from the image sensing module at a predetermined frequency, deriving differential changes between the images, processing the differential changes into a control signal representing a movement of the apparatus imparted by a user, and outputting the control signal to the host unit to position the cursor on the display screen.

A method for concurrently controlling a cursor displayed on a display screen of a display unit using a mouse apparatus, in accordance with another preferred embodiment, is provided. The display unit is connected to a host unit of an information technology system. The display screen has a plurality of light sources fixedly disposed near edges thereof. The mouse apparatus comprises a light pointer, an image sensing module and a processor. The method comprises steps described in the following: emitting invisible light in a predetermined wavelength range toward the image sensing module by the light sources; imparting a command movement to the light pointer; emitting invisible light in the predetermined wavelength range toward the display screen and forming an invisible light spot thereon using the light pointer; reflecting the light spot formed on the display screen toward the image sensing module; capturing images of light emitted from the light sources and the light spot reflected from the display screen by the image sensing module; and receiving the images captured by the image sensing module at a predetermined frequency, deriving differential changes between the images, processing the differential changes into a control signal representing the commanding movement, and outputting a control signal to the host unit to position the cursor on the display screen using the processor.

### BRIEF DESCRIPTION OF THE DRAWING

Many aspects of the present mouse apparatus and method for concurrent cursor control can be better understood with reference to the following drawings. The components in the drawings are not necessarily drawn to scale, the emphasis instead being placed upon clearly illustrating the principles of the present apparatus and method for concurrent cursor control.

FIG. 1 is a schematic view of an exemplary information technology system equipped with an exemplary mouse apparatus in accordance with a preferred embodiment.

### DETAILED DESCRIPTION OF THE EMBODIMENT

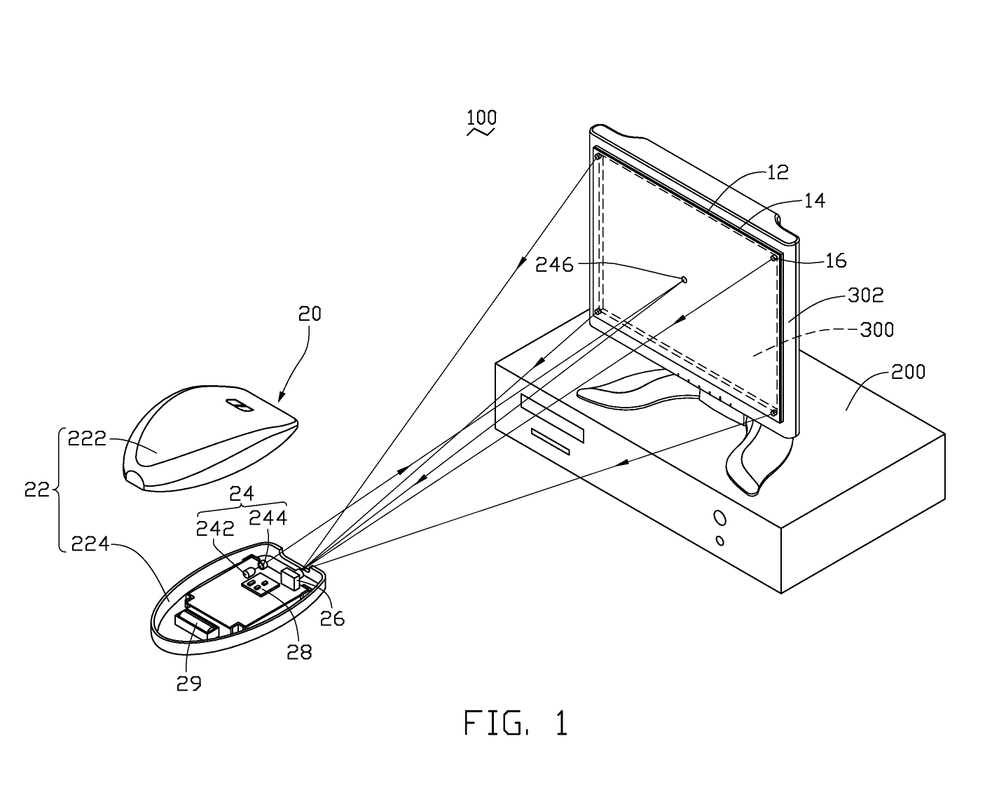

Referring to FIG. 1, in accordance with a preferred embodiment, an information technology system 100 for concurrently controlling a cursor displayed on a display screen 300 of a display unit 302 is provided. The information technology system 100 includes a mouse apparatus 20, a host unit 200 and the display unit 302. The display unit 302 is connected to the host unit 200. The mouse apparatus 20 includes a transparent board 12, a selectively reflective layer 14, multiple light sources 16, a housing 22, a light pointer 24 disposed in the housing 22, an image sensing module 26 and a processor 28.

Attached to and in contact with the display screen 300, the transparent board 12 has a size compatible with the display screen 300. The selectively reflective layer 14 can contain metal particles or particles of metal oxide and is deposited on the transparent board 12 by vacuum evaporation. The selectively reflective layer 14 is transmissive to visible light and reflective only to infrared light in a specific wavelength range, for example, from 980 nm to 1000 nm. In this embodiment, the display screen 300 and the transparent board 12 have an essentially square shape and there are four light sources respectively fixed upon the four corners of the transparent board 12. The light sources 16 are light emitting diodes (LEDs) emitting infrared light of a predetermined wavelength such as 980 nm.

Because both the transparent board 12 and the selectively reflective layer 14 are transmissive to visible light, and both the light that can be reflected by the selectively reflective layer 14 and the light that the light sources 16 emit is infrared light, the incorporation of the transparent board 12, the selectively reflective layer 14 and the light sources 16 does not compromise the proper operation of the display screen 300 by any means.

It is understood if the selectively reflective layer 14 is directly deposited on the display screen 300 and the multiple light sources 16 are directly fixed onto the display unit 302, the transparent board 12 can be eliminated. In addition, if the display screen 300 can selectively reflect infrared light by itself, the selectively reflective layer 14 can be eliminated.

The housing 22 has an upper part 222 and a lower part 224. The light pointer 24 includes a LED light source 242 and a collimator 244. The LED light source 242 emits infrared light of a wavelength that preferably falls into the reflecting wavelength range of the selectively reflective layer 14. The infrared light emitted by the LED light source 242 is further adjusted in direction and intensity by the collimator 244 and forms a light spot 246 on the display screen 300. The light spot 246 can be reflected by the selectively reflective layer 14 toward the image sensing module 26. It is understood that the direction and the intensity of light from the light spot 246 reflected by the selectively reflective layer 14 depend on the characteristics of the collimator 244 as well as the flatness of the selectively reflective layer 14.

The image sensing module 26 includes a filter, a lens and an image sensor (not shown). The filter is transmissive to only infrared light. The lens is configured for focusing incoming light into an image on the image sensor. The image sensor includes multiple imaging pixels, each of which can sense light in a wavelength range of 980 nm to 1000 nm. In this embodiment, the image sensing module 26 receives infrared light from the light spot 246 reflected by the selectively reflective layer 14 as well as infrared light coming from the multiple light sources 16 and captures images thereof. When a user moves the mouse apparatus 20 as a command, the light pointer 24 inside the apparatus 20 moves accordingly, and so does the light spot 246 emitted by the pointer 24 and formed on the display screen 300. During this movement, the image that the image sensor receives undergoes a corresponding change. More particularly, the relative positional relationship between the image formed by light from the light spot 246 after being reflected by the selectively reflective layer 14 and the images of the multiple light sources 16 changes with the movement of the mouse apparatus 20. The processor 28 is configured to receive images from the image sensing module 26 at a predetermined frequency, derive a differential change of the relative positional relationship mentioned above from the images, and process such change into a control signal which represents the commanding movement of the user and can be adapted to concurrently control a cursor displayed on the display screen 300.

The host unit 200 is a main unit of an information technology system 100. The information technology system 100 can be a computer, a television, a gaming machine, etc. The mouse apparatus 20 is connected to the host unit 200 through a circuit for transmitting a control signal from the processor 28 to the host unit 200 so that the host unit 200 can in turn control the cursor displayed on the display screen 300 according to the control signal. Alternatively, as in this embodiment, a control signal is transmitted wirelessly from the mouse apparatus 200 to the host unit 200. A battery 29 is installed in the mouse apparatus 200 as a power supply. A wireless transmitter (not shown) is installed on the processor 28 for transmitting a control signal that the processor 28 generates. A wireless receiver compatible with the wireless transmitter is installed in the host unit 200 for receiving the control signal transmitted by the wireless transmitter so that the host unit 200 can further process this signal to concurrently control the cursor displayed on the display screen 300.

In this embodiment, by using optical imaging and signal processing, the movement a user imparts to the mouse apparatus 20 for concurrently controlling the cursor is not confined in any two-dimensional plane. In other words, the user can concurrently control a cursor by moving the mouse apparatus 20 in a three-dimensional manner. Such freedom provided by the mouse apparatus 20 gives the user extra convenience and flexibility in concurrent cursor control.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A mouse apparatus for controlling movement of a cursor on a display screen of a display unit of an information technology system, the mouse apparatus being in communication with a host unit of the information technology system, the display unit being connected to the host unit, the mouse apparatus comprising:
a light pointer configured for emitting invisible light in a predetermined wavelength range toward the display screen;
a selectively reflective layer disposed over the display screen, the selectively reflective layer being transmissive to visible light and reflective to the invisible light from the light pointer, thereby an invisible light spot is formed by the light pointer on the selectively reflective layer;
a plurality of light sources disposed on the display screen, the light sources being spaced apart from each other;
an image sensing module configured for capturing images of the light sources and the invisible light spot;
a processor configured for receiving the images from the image sensing module at a predetermined frequency, analyzing differential changes between the images caused by a movement of the mouse apparatus imparted by a user, processing the differential changes into a control signal, and outputting the control signal to the host unit to control movement of the cursor on the display screen in response to the movement of the mouse apparatus.

2. The mouse apparatus as claimed in claim 1, wherein the light pointer comprises an infrared light emitting diode (LED) and a collimator configured for adjusting the position and the size of the invisible light spot emitted by the infrared LED and formed on the display screen.

3. The mouse apparatus as claimed in claim 1, wherein the display screen has a square shape and the plurality of light sources are respectively disposed on the four corners of the display screen.

4. The mouse apparatus as claimed in claim 1, wherein the plurality of light sources are infrared light emitting diodes (LEDs) and the image sensing module includes an infrared light image sensor.

5. The mouse apparatus as claimed in claim 1, further comprising a transparent board, the transparent board being disposed between the display screen and the plurality of light sources, and the transparent board having a size compatible with the display screen.

6. The mouse apparatus as claimed in claim 5, wherein the selectively reflective layer is deposited on the transparent board.

7. The mouse apparatus as claimed in claim 1, wherein the image sensing module comprises a filter, at least a lens, and an image sensor.

8. The mouse apparatus as claimed in claim 7, wherein the filter is configured for transmitting only infrared light and the image sensor is configured for sensing only infrared light.

9. The mouse apparatus as claimed in claim 1, wherein the mouse apparatus is connected to the host unit by a wire.

10. The mouse apparatus as claimed in claim 1, wherein the mouse apparatus is in wireless communication with the host unit, the mouse apparatus has a wireless transmitter, and the host unit has a wireless receiver for receiving wireless signals transmitted by the wireless transmitter.

11. A mouse apparatus for controlling movement of a cursor displayed on a display screen of a display unit of an information technology system, the mouse apparatus being in communication with a host unit of the information technology system, the display unit being connected with the host unit and equipped with a plurality of light sources disposed near edges of the display screen thereof, the plurality of light sources configured to emit light in a predetermined wavelength range, the display screen being configured for reflecting light in the predetermined wavelength range, the mouse apparatus comprising:
a light pointer configured for emitting invisible light in the predetermined wavelength range toward the display screen and forming an invisible light spot on the display screen;
an image sensing module configured for capturing images of the light sources and the invisible light spot;
a processor configured for receiving the images from the image sensing module at a predetermined frequency, analyzing differential changes between the images associated with a movement of the mouse apparatus imparted by a user, processing the differential changes into a control signal, and outputting the control signal to the host unit to control the movement of the cursor on the display screen.

12. An information technology system, comprising:
a host unit;
a display unit connected to the host unit and having a display screen; and
a mouse apparatus, the mouse apparatus comprising:
a light pointer configured for emitting invisible light in a predetermined wavelength range toward the display screen;
a selectively reflective layer disposed over the display screen, the selectively reflective layer being transmissive to visible light and reflective to light in the predetermined wavelength range, thus the light pointer forms an invisible light spot on the selectively reflective layer;
a plurality of spaced light sources disposed on the display screen;
an image sensing module configured for capturing images of the light sources and the light spot; and
a processor configured for receiving the images from the image sensing module at a predetermined frequency, analyzing differential changes between the images associated with a movement of the mouse apparatus imparted by a user, processing the differential changes into a control signal and outputting the control signal to the host unit to control movement of the cursor on the display screen.

13. The information technology system as claimed in claim 12, wherein the information technology system further comprises a transparent board, the transparent board being disposed between the display screen and the plurality of light sources and having a size compatible with the display.
